(19) United States
(12) Patent Application Publication
(10) Pub. No.: US 2016/0110807 A1
(43) Pub. Date: Apr. 21, 2016

(54) CONTAINER SHIPPING CONTRACT EXCHANGE SYSTEM

(71) Applicant: Gordon Downes, Gilbert, IL (US)

(72) Inventor: Gordon Downes, Gilbert, IL (US)

(21) Appl. No.: 14/516,123

(22) Filed: Oct. 16, 2014

(51) Int. Cl. G06Q 40/04; G06Q 10/08

(52) U.S. Cl. CPC G06Q 40/04; G06Q 10/083

(57) ABSTRACT

A computerized exchange for trading container shipping contracts for the future physical transportation of cargo loaded inside a shipping container is provided that comprises an offer module capable of posting thousands of contracts for sale at an offer price published on the computerized exchange. The shipping exchange provides a matching module capable of simultaneously matching thousands of contracts offered on the computerized exchange to a corresponding bid and transform in the offers to purchased contracts. A settlement made capable of notifying carriers identified by the contracts of an obligation to physically transport cargo loaded into a shipping container according to the terms of the contracts is provided.

The present invention pertains to futures contracts for containers for shipping cargo and an exchange for trading such container shipping contracts and a carrier and shipper optimization system for managing the booking of shipping containers via the exchange.

### BACKGROUND OF THE INVENTION

The present invention is in the technical field of container shipping contracts. More particularly, the present invention is in the technical field of methods and systems for the trading of container shipping contracts.

Conventional container shipping, service contracts are negotiated directly between carriers and beneficial cargo owners. The prices or “freight rates” of container shipping service contracts are typically subject to change during the contract period depending on market conditions. This allows unexpected and often volatile changes to freight rates. Variable and volatile freight rates undermine the efficiency of the container shipping process for both beneficial cargo owners and carriers.

Container freight indexes have been established to track freight rate variation and volatility. Shipping, exchanges and brokers have developed container freight derivative contracts that are based on container freight indexes. Carriers, beneficial cargo owners and others may trade container freight derivative contracts in an effort to hedge against or speculate on freight rate variation and volatility. However, container freight indexes and derivative contracts are not based on individual carrier contracts. Thus, changes in the price of container freight derivative contracts may not correlate to changes in direct earner contracts. Consequently, carriers and beneficial cargo owners are unable to completely hedge against container freight variation and volatility.

Thus, there is a need for methods and systems that enable the trading of container shipping contracts based on underlying carrier commitments to provide transportation services. Therefore it is an object of the invention to provide methods and systems far the trading of such container shipping contracts on a computer-based shipping exchange.

### SUMMARY

These and other objects of the invention are accomplished in accordance with the principles of the present invention by providing methods and systems for the trading of container shipping contracts.

In accordance with the invention, these methods and systems provide a computer-based shipping exchange suitable for use by carriers, beneficial cargo owners and other traders. Tradable container shipping contracts may be based on underlying carrier commitments to transport physical goods as specified in the contract terms. The shipping exchange may provide detailed information on the container shipping contract terms and real-time trading statuses such as buy and sell quotes. Quotes may be matched and executed automatically by the shipping exchange. Data suitable for contract evaluation may be provided to traders. Computer based models for analyses of the effect of various factors on the valuation of container shipping contracts may also be provided. Container shipping contracts may be traded individually or by category groupings. Container shipping contracts may be traded online for both initial offerings as well as subsequent offerings. Additionally, offer and contract terms for categories of container shipping contracts may be standardized in the shipping exchange for simplification.

The present invention provides for a computerized exchange for trading container shipping contracts for the future physical transportation of cargo loaded inside a shipping container comprising an offer module capable of posting thousands of contracts for sate at an offer price published on the computerized exchange, a matching module capable of simultaneously matching thousands of contracts offered on the computerized exchange to a corresponding bid and transforming, the offers to purchased contracts and a settlement module capable of notifying carriers identified by the contracts of an obligation to physically transport cargo loaded into as shipping container according to the terms of the contracts.

In an embodiment, the invention further comprising a contract display module capable of automatically displaying thousands of currently available contracts offered for purchase by registered traders. In an embodiment, the invention further comprising matching engine capable of automatically matching thousands of available contracts upon the acceptance of each offer.

In an embodiment, the invention further comprising a transfer module capable of automatically transferring the ownership of thousands of contracts from one registered carrier or trader to another upon acceptance of an offer and upon the confirmation of payment or clearance. In an embodiment, the invention further comprising a resale module capable of posting thousands of purchased contracts on the computerized exchange for resale. In an embodiment, the invention further comprising a delivery module capable of booking thousands of contracts with each carrier listed on the contract, thereby facilitating the loading of cargo into a standard shipping container and the physical transportation of the container and cargo for ocean transport.

In an embodiment, the invention further comprising a filing module capable of filing thousands of reports and contracts with commissions and government entities to facilitate compliance with transport regulations. In an embodiment, the invention further comprising a data module capable of collecting, processing and displaying thousands of data points including contract offers, bids, sales, resale prices sortable according to at least one of the following categories: carrier, departure window, container size, container type, type of shipping service, tier of shipping service, delivery date, time in transport and rating of quality of carrier.

In an embodiment, the invention having the data module is searchable in order for a shipper to locate an appropriate container by searching by a parameter including one of a carrier, departure window, container size, container type, type of shipping service, tier of shipping service, delivery date, time in transport and rating of quality of carrier.

In an embodiment, the invention further comprising a carrier optimization system including one of an aggregated information module, batch container trading module, automated trading module, utilization module, yield module, benchmark module, trend module, alert module, enterprise resource planning module, shipper transport management module, shipper warehouse management module, shipping forecast module, contract portfolio module, and contract delivery module.

In an embodiment, the invention having the carrier optimization system provides analysis according to at least one of cargo ready dates, cargo ready reliabilities, cargo delivery dates, cargo delivery priorities, shipping forecasts, shipping contract terms and prices, transit times, reliabilities, frequency of service departures, average port-to-port transit times, variance from the mean transit time and the percentage of deliveries within scheduled delivery time. In an embodiment, the invention having a uniform contract for the future physical sea transportation of cargo loaded into a standard shipping container, where the contract includes at least one of place(s) of receipt, place(s) of delivery, carrier name, departure date window, container size and container type. In an embodiment, the invention having the contract provide for shipping container usage and the contract specifying a price that represents the amount a shipper will pay on the date the contract is purchased or the date the container is hooked and the carrier receiving payment upon acceptance of the contract.

In an embodiment, the invention comprising a data module capable of collecting, processing and displaying thousands of data points including contract offer, sell, resell prices and TEUs sortable according to at least one of the following categories: carrier, departure window, container size, container type, container conversion charges and contract rating and the computerized exchange capable of operating each of the contract display, contract bid, bid processing, re-sell delivery, reporting and data modules simultaneously in order to provide a generally transparent and efficient marketplace for the trading shipping contracts. In an embodiment, the invention comprising a contract that provides for segmentation of a shipping, container and pricing of the contract according to a fractional shine of a standard shipping container.

The present invention also includes a non-transitory computer readable medium having stored therein instructions executable by a processor to operate a computerized exchange for trading container shipping contracts, wherein the instructions include first code instructions for posting thousands of the contracts for sale at an offer price posted on the computerized exchange, second code instructions far simultaneously matching thousands of the contracts on the computerized exchange with a corresponding bid, each offered contract being transformed to a purchased contract and third code instructions for notifying carriers identified by the contracts of an obligation to physically transport containers according to the terms of the contracts. In an embodiment, the invention including code instructions for posting thousands of purchased contracts on the computerized exchange for resale.

The invention further provides a computerized method for managing future physical transportation of cargo loaded inside a shipping container comprising the steps of posting, by a special purpose computer, thousands of shipping container contracts for sale at an offer price, simultaneously matching, by the special purpose computer, thousands of the contracts to a corresponding bid and transforming the offered contracts to purchased contracts, posting, by the special purpose computer, thousands of purchased contracts for resale and notifying carriers identified by the contracts of an obligation to physically transport shipping containers according to the terms of the contracts. In an embodiment, the invention including the step of displaying, by the special purpose computer, purchased contract parameters including one of a carrier, departure window, container size, container type, type of shipping service, tier of shipping service, delivery date, time in transport and rating of quality of carrier.

### BRIEF DESCRIPTION OF THE DRAWINGS

These and other objects and advantages of the invention will become apparent upon reading the following detailed description and upon reference to the drawings in which:

FIG. 1 is a representation of a screen shot of a sample container shipping contract that may be provided to traders in accordance with the present invention;

FIG. 2 is a logic flow diagram for an embodiment of the container shipping contract trading process in accordance with the present invention;

FIG. 3a is a schematic block diagram of an embodiment of the module components that comprise the shipping exchange system of the present invention;

FIG. 3b is schematic block diagram of an alternate embodiment of the module components that may comprise the shipping exchange system of the present invention;

FIG. 4 is a schematic view of the computers and servers that comprise the shipping exchange system of the present invention;

FIG. 5 is a schematic block diagram of some of the parties participating in the shipping exchange system of the present invention;

FIG. 6 is a schematic representation of container shipping contract trading data search and display system in accordance with the present invention;

FIG. 7 is a schematic block diagram illustrating an embodiment of the carrier optimization system in accordance with the present invention;

FIG. 8 is a representation of a schematic view of the carrier optimization module in accordance with the present invention;

FIG. 9 is a schematic block diagram illustrating an embodiment of the shipper optimization system in accordance with the present invention;

FIG. 10 is a logic flow diagram for an embodiment of the shipper contract portfolio optimization system in accordance with the present invention;

FIG. 11 is a representation of a schematic display of shippers optimization module in accordance with the present invention;

FIG. 12 is a logic flow diagram for an embodiment of the delivery of a container shipping contract in accordance with the present invention; and

FIG. 13 is a logic flow diagram for an embodiment of the measurement and rating of container shipping contracts in accordance with the present invention.

### DETAILED DESCRIPTION OF THE INVENTION

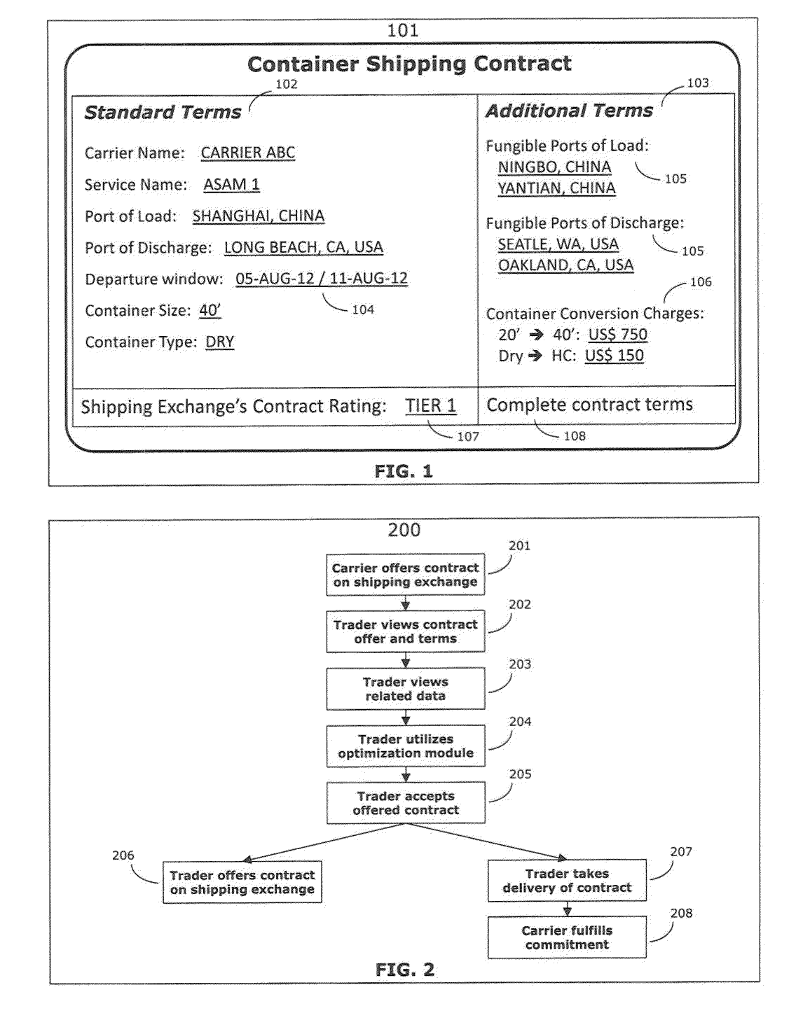

The present invention is directed to methods and systems for trading of container shipping contracts in a shipping exchange that is exemplified with respect to FIGS. 1-13.

A tradable container shipping contract is illustrated in FIG. 1. The contract display 101 informs the trader of the standard 102 and additional 103 terms. The standard terms 102 contain basic information about the shipping services to be provided. The departure date window 104 sets the earliest and latest date that a carrier can provide the services. The carrier may stipulate any fungible terms 105 in the underlying commitment and initial offering of the contract. Fungible terms, for example, may include the ports of load and discharge. Similarly, the carrier may also stipulate fixed conversion charges 106, such as for the conversion from one type of container to another. Container shipping contracts may be rated 107 by the shipping exchange according to data and factors relevant to the contract. Other terms of the tradable container shipping contract may be viewed in the complete terms 108 as published by the shipping exchange.

FIG. 2 shows the logic flow diagram depicting the process for trading container shipping contracts on the shipping exchange 300. A tradable container shipping contract is created when a carrier offers to sell 201 an underlying commitment for the physical transportation of the cargo according to the contract terms. The trader may view the offer and terms 202 as well as related data 203. The trader may also use optimization systems and methods 204 as made available by the shipping exchanger. If the trader accepts the offered price for the tradable container shipping contract 205, the exchange may immediately transfer ownership of the contract to the trader. The trader will have the option to offer the contract on the exchange 206, or take delivery of the contract 207. In taking delivery of the contract, the trader may require the carrier to fulfill the underlying commitment 208 to provide containerized transportation as per the contract terms.

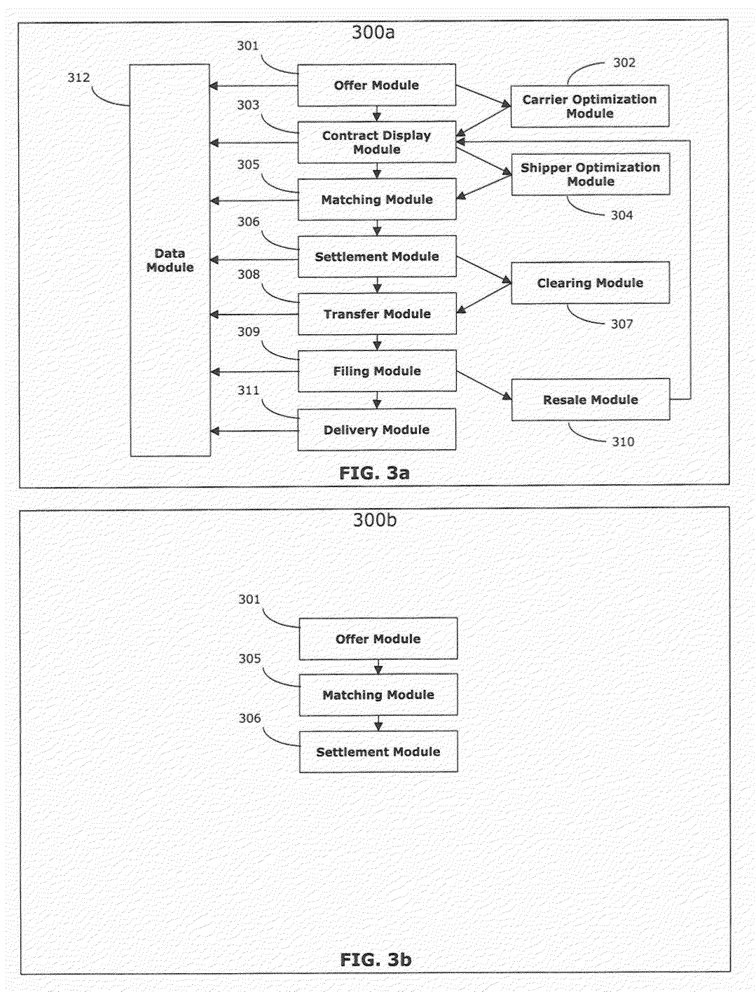

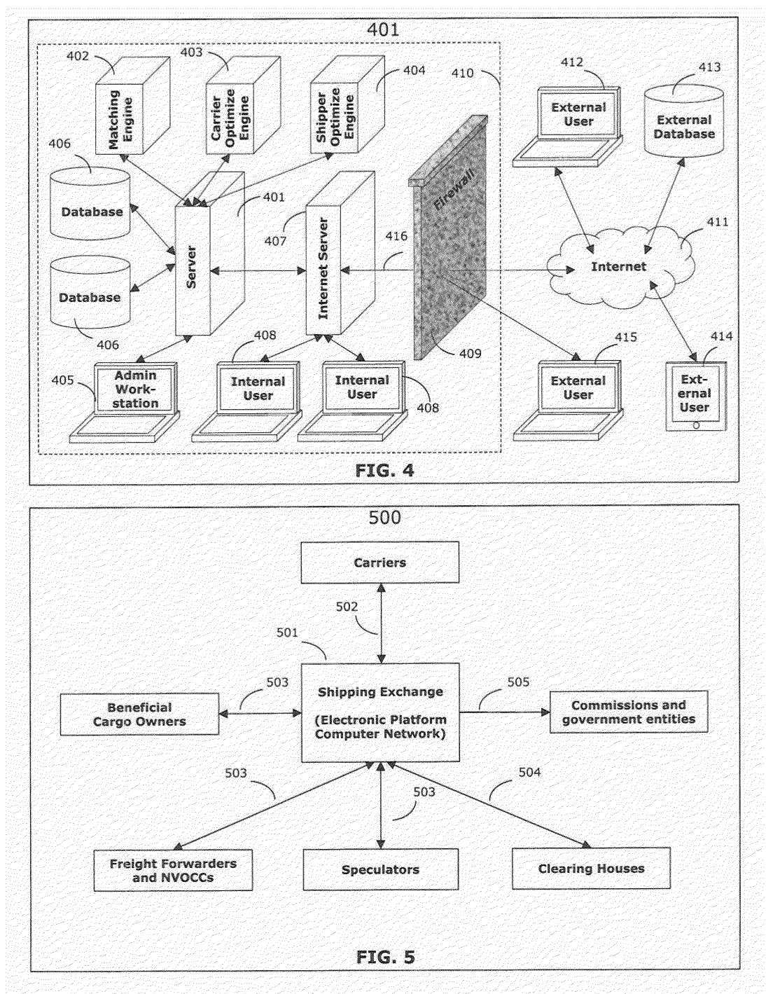

Turning to FIGS. 3a, b the components of the shipping exchange system are described in more detail. In an embodiment, the system operates using a specially programmed computer including software modules to accomplish the trading for the shipping exchange system. FIG. 3a discloses a fully functioning and fully realized shipping exchange system having more than six functioning modules. FIG. 3b discloses a basic, early roll-out of a shipping exchange system where the basic three modules are provided. With respect to the basic system as depicted in FIG. 3b, the shipping exchange 501 (FIG. 5) includes an offer module 301, matching module 305 and settlement module 306. These modules 301, 305, 306 allow for the posting of container shipping contracts on the exchange by a carrier, the matching to the offer to a corresponding bid from a shipper and the settlement of the contract by notifying the carrier of its obligation to transport the container according to the contract terms. The shipping exchange 501 (FIG. 5) offer module 301 transmits offers from carriers to sell container shipping contracts at preset pricing for a purchase on the exchange 501. The offer module comprises software running on the trading server 401 (FIG. 4) or matching engine 402 (FIG. 4).

In an alternate embodiment with respect to FIG. 3a, additional modules are provided that comprise the shipping exchange electronic system 501 (FIG. 5). An offer module 301 and matching module 305 are provided as discussed previously. A resale module 310 is provided that is capable of posting previously purchased shipping container contracts on the computerized contract exchange 401 (FIG. 4) for resale. For example, where a shipper had previously purchased a contract for a carrier shipment from Hong Kong to Singapore and the shipment must now be shipped from Hong Kong to Malaysia; the shipper must alter the logistics by selling the original Hong Kong to Singapore contract and putting it up for resale on the exchange 401. The shipper will then purchase a new contract on the exchange from Hong Kona to Malaysia. The shipper may purchase an original contract offered by a carrier or an already purchased contract up for resale by another party, such as a shipper.

The shipping exchange 300a may also include a filing module 309 that provides for the automatic filing of documentation with governments and commissions in order to facilitate with compliance with transport regulations. The exchange may charge the parties involved in the contract extra fees to provide the filing service or may include the cost of such filings with the service fees incurred at the nine the contracts are purchased. The exchange 300a may also include a settlement module 306 as discussed above.

Further, the shipping exchange 501 (FIG. 5), 300a may include a contract display module 303 that can automatically display thousands of currently available contracts offered for purchase by registered traders. The contracts may be displayed by well-known means such as transmission via the internet to a participant's computer or mobile device such as a smartphone and participants may view the available contracts according to multiple categories as described below. A transfer module 308 may be provided by the shipping exchange 501 (FIG. 5) The transfer module may provide for the automatic transfer of the ownership of the contracts from one registered carrier or trader to another, upon acceptance of an offer and upon confirmation of the payment or clearance. The transfer module 308 may handle thousands or hundreds of thousands of transactions and ownership transfers simultaneously. The transfer process may include electronic notifications via e-mail, EDI, API or other EFS means and/or paper documents where necessary.

The exchange 501 (FIG. 5) may also include a delivery module 311 that provides for the booking of contracts with each carrier listed on the contract in order to facilitate the loading of the cargo into the shipping container and transportation of the container for ocean transport. Once a contract booking is accepted, it is cargo is delivered to the carrier listed on the contract. The delivery module system 311 is capable of handling thousands and hundreds of thousands of files simultaneously.

The shipping exchange 501 (FIG. 5) may also include a data module 312 that is capable of collecting, processing and displaying thousands or hundreds of thousands of data points involved in the transactions occurring on the shipping exchange 501 (FIG. 5). The data points may include contract offers, bids, sales, resale prices. These items may be sortable according to carrier, departure window, container size, container type, type of shipping service, tier of shipping service, delivery date, time and transport and rating of the quality of the carrier. The data module 312, in an embodiment, receives data input from modules 301, 303, 305, 305, 308, 309 and 311 as depicted in FIG. 3a. The data module 312 allows for searching in order to locate an appropriate shipping container described in a contract 101 by multiple parameters. Such parameters may include the carrier name, departure window, container size, container type, tier of shipping service, delivery date, time and transport and rating of quality of carrier.

The shipping exchange 501 (FIG. 5) may also include a carrier optimization module 302. The carrier optimization module provides data collected during the processing of contracts on the shipping exchange 501 (FIG. 5) and includes arm aggregated information module, batch container trading module, automated trading module, utilization module, yield module, bench mark module, trend module, alert module, enterprise resource planning module, shipping transport management module, shipper warehouse management module, shipping forecast module contract portfolio module and contract delivery module. The carrier optimization module 302 may also provide analysis according to cargo ready dates, cargo ready reliabilities, cargo delivery dates, cargo delivery priorities, shipping forecast, shipping contract terms and prices, transit times, reliabilities, frequency of service departures, average port-to-port transit times, variance from the mean transit time and percentage of deliveries within scheduled delivery time.

Further, the shipping exchange 501 (FIG. 5) may include a shipper optimization module 304. The shipper optimization module 304 may include a shipper enterprise resource planning system, a shipper transport management system or a shipper warehouse management system. The shipper optimization system may analyze cargo ready dates, cargo ready reliabilities, cargo delivery dates, cargo delivery priorities, shipping contract terms and prices, shipping contract transit times, shipping contract liabilities and shipping forecasts and optimal contract portfolio calculations and dynamic portfolio adjustments. Each of the above discussed modules may be used in combination in a single shipping exchange 501 (FIG. 5) In alternate embodiments some of the modules may be used while others are omitted from the particular snipping exchange system.

FIG. 4 depicts the hardware such as specially programmed and special purpose computers and servers and the internet that control the shipping exchange of the present invention. The shipping exchange 410 (501 (FIG. 5)) includes a special purpose trading server 401, connected via webserver 407 to the internet 411. The trading server 401 is specially programmed in order to interact and connect with trading engines for matching 402, carrier optimization 403 and shipping optimization 404 that operate the shipping exchange 410. The special purpose Matching Engine 402 or trading server 401 may operate the other modules 301-312 described in FIG. 3a. Databases 406 maintain the trading information settled, transferred, delivered, filed, optimized contract data. Administration computer 405 is included in the shipping exchange 410. Also provided are computers 408 for internal users/traders at the physical location of the shipping exchange computers 410. External users of the shipping exchange 410 may access the system via computers 412, 415 or mobile devices such as smartphones or tablets 414 via the internet 411. The information transmitted by the external users (e.g. traders, speculators, shippers, carriers, etc.) or from the shipping exchange 410 may be saved in a cloud server or database 413. A firewall 409 provides secure transmissions into the shipping exchange 410 using systems such as Apache Tomcat or Apache Hadoop or similar software.

FIG. 5 is a block diagram illustrating an embodiment of the container shipping contract trading system 500 and all of its participants. The shipping exchange 501 may act as the electronic platform 410 (FIG. 4) displaying contract offers and facilitating the acceptance of offers, as well as corresponding payments, and other related information and activities. The shipping exchange may allow trading transactions and other activities through, for example, an Internet link 411, a telephone network link, a cable or fiber optic link, a microwave link, to combination of such links, or any other suitable communication link 416 (FIG. 4). As outlined in FIG. 2, the container shipping contract (FIG. 1) is created by the carrier 502 offering an underlying commitment on the shipping exchange 500. In addition to offering container shipping contracts for sale on the exchange, the carrier 502 may also buy and trade contracts. Beneficial cargo owners, speculators, freight forwarders and NVOCCs (non vessel owning common carriers) 503 may trade container shipping contracts and access other data, information, analyses and methods on the shipping exchange. Clearing houses 504 may facilitate payments to and from the shipping exchange 410. The shipping exchange may file contract and trade information with relevant government entities and commissions 505.

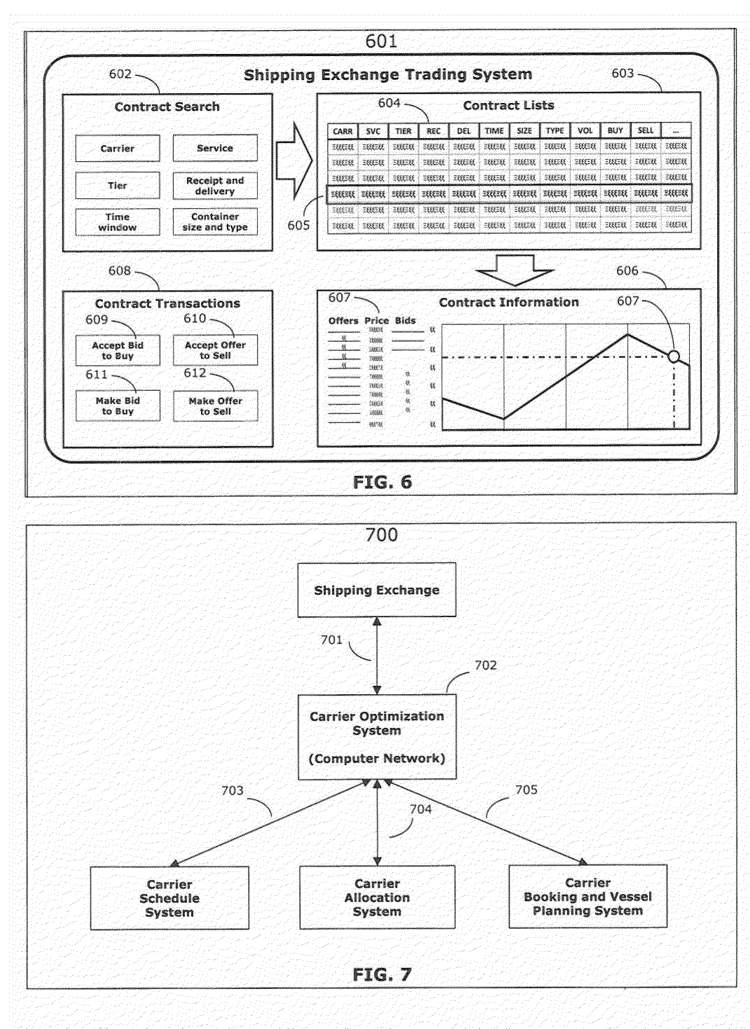

The shipping exchange may provide traders with a display 601 of container shipping contract trading statuses trough an electronic platform, as referenced in FIG. 6. The display may allow contracts and other information to be searched 602 for either individually or in specified groups and collections. Contracts may be searched for by any form or variation of the following; carrier name, service name, contract rating, place of receipt or port of load, place of delivery or port of load; departure time window, container size, container type, offered or historic price, contract number, or any other relevant contract criteria. Contract search results may be returned in list format 603, in individual contract format 101, or any other formats. Contracts and other information may also be listed by the exchange in customizable tables 604. The tables may allow for; column addition or removal, row sorts, filters, sub totals, mathematical equations, and other customization. Contract lists may utilize interactive user interfaces 605 to enhance the user experience. For example, the user may be able to move a mouse pointer over a listed, contract 605, and immediately view the related contract information 606. Contract information may be displayed in multiple graphical and numerical formats. Contract information may include historic and live data, future projections, market spreads, ratios, comparative analyses, benchmarks, and other data. Contract information may utilize interactive user interfaces 607 to enhance the user experience. For example, the user may be able to move a mouse pointer over a graphical data point, and immediately view the market spread and other related information. The shipping exchange may allow traders to perform contract transactions 608 based on the displayed contracts, contract search results, contract lists, contract information, or any other display. The shipping exchange may enable traders to accept existing offers to sell contracts 609, accept existing offers to purchase contracts 610, make offers to buy contracts 611, and make offers to sell contracts 612.

FIG. 7 is a block diagram illustrating an embodiment of the carrier optimization system, as an extension of the shipping exchange 701. The carrier optimization system 702 may receive, store, process and transmit data to and from the shipping exchange, carrier schedule systems 703, carrier allocation systems 704, and carrier booking and vessel planning systems 705. The carrier optimization system may receive data through, for example, an Interact link, a telephone network link, a cable or fiber optic link, a microwave link, a combination of such links, or any other suitable communication link.

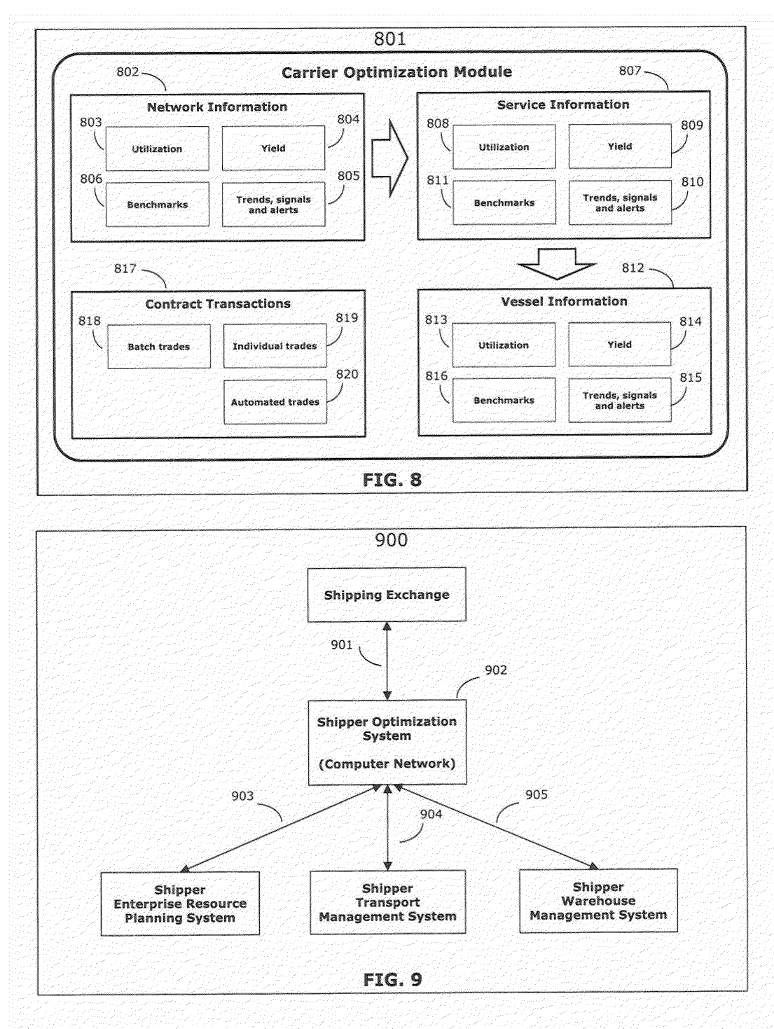

The carrier optimization module 801 as depicted in FIG. 8, may provide carriers with customizable analyses of information and trading methods 601 through an electronic platform, as referenced in FIG. 6. The display may provide analyses of information that allow carriers to monitor their networks 802. Network information may be analyzed and displayed as utilization 803, yield 804, statistical trends, statistical signals, customizable statistical alerts 805, and benchmarks 806. Benchmarks may include aggregated information from all carriers, as well as specific information from identified carriers. Network information may be displayed in multiple graphical and numerical formats, with customizable layouts that may allow carriers to view developments over time and or in comparisons with other relevant information. The display may also provide analyses of information that allow earners to monitor their services 807. Service information may be analyzed and displayed as utilization 808, yield 809, statistical trends, statistical signals, customizable statistical alerts 810, and benchmarks 811. Benchmarks may include aggregated information from all carriers, as well as specific information from identified carriers. Service information may be displayed in multiple graphical and numerical formats, with customizable layouts that may allow carriers to view developments over time and or in comparisons with other relevant information. The display may also provide analyses of information that allow earners to monitor their vessels 812. Vessel information may be analyzed and displayed as utilization 813, yield 814, statistical trends, statistical signals, customizable statistical alerts 815, and benchmarks 816. Benchmarks may include aggregated information from all carriers, as well as specific information from identified carriers. Vessel information may be displayed in multiple graphical and numerical formats, with customizable layouts that may allow carriers to view developments over time and or in comparisons with other relevant information. The carrier optimization module may allow carriers to perform contract transactions 817 based on the displayed network, service and vessel information. The carrier optimization module may enable carriers to trade in batches of contracts 818 or individual contracts 819. The module may enable earners to set-up automatic contract trades that will occur on the fulfillment of conditions specified by the carrier 820.

FIG. 9 is a block diagram illustrating an embodiment of the shipper optimization system, as an extension of the shipping exchange 901. The shipper optimization system 902 may receive, store, process and transmit data to and from the shipping exchange 901, shippers enterprise resource planning systems 903, shippers transport management systems 904, and shippers warehouse management systems 905. The shipper optimization module 902 may receive data through, for example, an Internet link, a telephone network link, as cable or fiber optic link, a microwave link, a combination of such links, or any other suitable communication link.

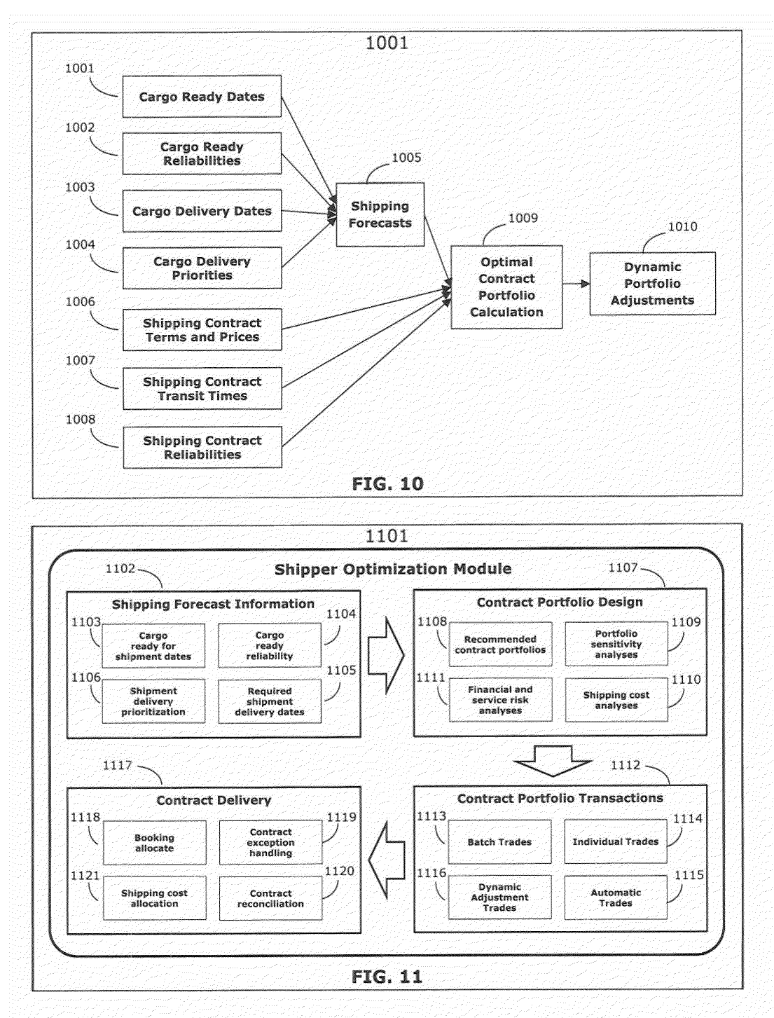

FIG. 10 shows the logic flow diagram for analyses and methods that may be performed by the shipper optimization system 902, 1001. Data may be gathered from linked shipper systems FIG. 9, which may include cargo ready dates 1001, cargo ready reliabilities 1002, cargo deliver dates 1003, cargo delivery priorities 1004. The data may be processed to create shipping forecasts 1005. The shipper optimization system may gather the following data from the shipping exchange; shipping contract terms and prices 1006, transit times 1007, and reliabilities 1008. The calculation of transit times and reliabilities for each figure is further described in FIG. 11. Shipping forecasts may then be processed together with the shipping exchange data to derive optimal portfolios 1009. Portfolios may be adjusted dynamically 1010 when changes occur to shipping forecasts or the contracts on the shipping exchange.

The shipper optimization module 1101 may provide shippers with customizable displays of information, analyses and trading methods through an electronic platform, as referenced in FIG. 11. the display may provide analyses of information that allow shippers to monitor shipping forecasts 1102. Shipping forecast information may be analyzed and displayed as dates of cargo readiness for shipment 1103, cargo ready reliabilities 1104, required shipment delivery dates 1105, shipment delivery prioritizations 1106. Shipping forecasts may be displayed and analyzed by receipt and delivery location, business entity, time period, purchase order, stock keeping unit, value and any other data that may be available in the linked systems in FIG. 11. Shipping forecasts may be amended and adjusted through a user interface into the shipper optimization system.

Shipping forecasts may be displayed in multiple graphical and numerical formats, with customizable layouts that may allow shippers to view developments over time and or in comparisons with other relevant information. The display may also provide analyses of information that allow shippers to calculate an optimal contract portfolio design 1009. Contract portfolio calculations and designs may be displayed as overall portfolio recommendations 1108, portfolio sensitivity analyses 1109, shipping cost simulations 1110 and financial and service risk simulations 1111. Contract portfolio calculations and designs may be displayed and analyzed by receipt and delivery location, business entity, time period, purchase order, stock keeping unit, value and any other data that may be available in the linked systems in FIG. 11. All aspects of the contract portfolio calculations and designs may be adjusted and simulated through a user interface into the shipper optimization system, Contract portfolio calculations and designs may be displayed in multiple graphical and numerical formats, with customizable layouts that may allow shippers to view developments over time and or in comparisons with other relevant information.

The shipper optimization system may allow shippers to perform contract transactions 1112 based on the portfolio calculations and designs. The shipper optimization system may enable shippers to trade in batches of contracts 1113 or individual contract trade 1114. The system may enable shippers to set up automatic contract trades that will occur on the fulfillment of conditions specified by the shipper 1115. The shipper optimization system may allow dynamic portfolio calculations and adjustments 1116 to initiate trades automatically 1115. The shipper optimization module 1101 may enable automatic contract delivery handling 1177. Contracts may be converted to bookings 1118 and allocated directly to planned shipments in the shippers' enterprise resource planning systems, transport management systems or warehouse management systems in FIG. 11. The shipper optimization systems may provide contract exception handling 1119 for instance, but not limited to, where carriers fail to deliver the underlying committed service according to contract terms. The system may provide contract reconciliations 1120 with the shipping exchange trading accounts, carriers and other entities. The system may provide shipment cost, allocations 1121 to receipt and delivery location, business entity, time period, purchase order, stock keeping unit and any other data that may be available in the linked systems displayed in FIG, 11. Shipment cost allocations 1121 may be customizable by the shipper according to the applicable accounting practices.

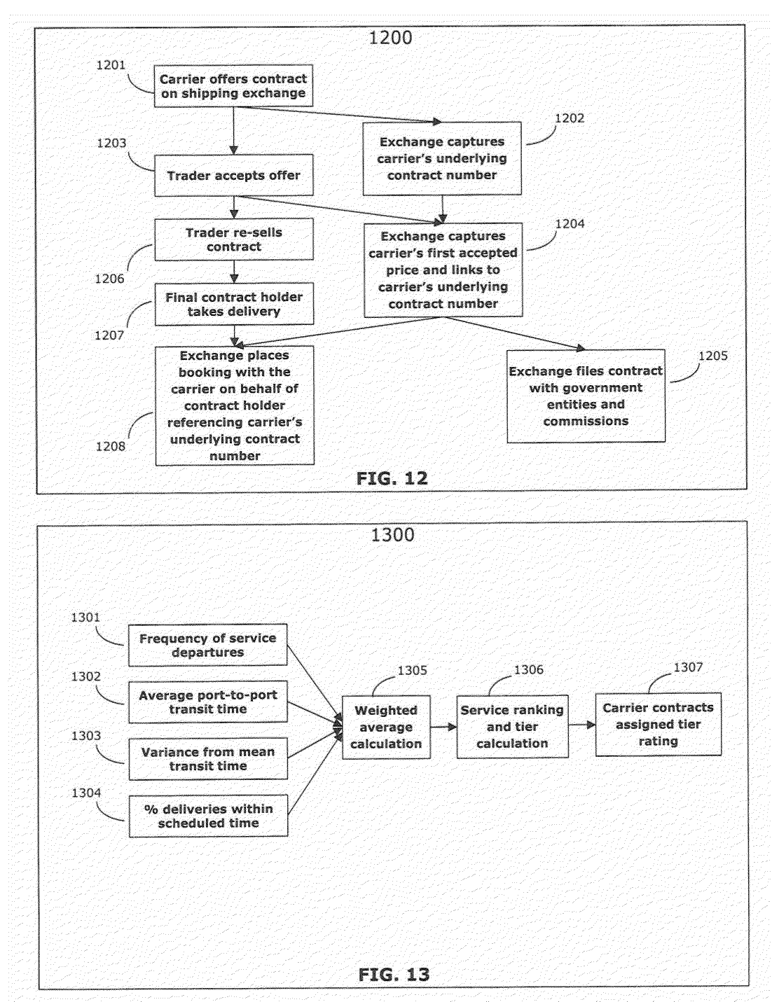

FIG. 12 shows the logic flow diagram for the delivery of a container shipping contract traded on the shipping exchange. The process flow may involve: The carrier offers an underlying commitment on the shipping exchange 1201. The Shipping exchange captures the unique carrier contract reference number 1202. Once a trader accepts the carrier offer the exchange records the first accepted prices against the unique carrier contract number 1204. The exchange files the contract terms and price with the government entities or commissions as required by law 1205. The contract may be resold by the trader and subsequent traders 1206. Once the final contract holder takes delivery of the contract 1207, the exchange then places a booking for shipment with the contracted carrier on behalf of the shipper 1208 with reference to the unique carrier contract number 1202 and first accepted price 1204.

FIG. 13 shows the logic flow diagram for the measurement and evaluation of container shipping contracts traded on the shipping exchange. The factors that may be measured by the shipping exchange include: frequency of service departures 1301, average port-to-port transit times 1302, variance from the mean transit time 1303, the percentage of deliveries within scheduled delivery time 1304. The measurements may be weighted and combined 1305 to determine a ranking for each carriers' service on a port-to-port basis 1306. Individual container shipping contracts may then he assigned a tier rating 1307 according to the ranking. The contract tier rating may provide a quantitative method to differentiate contracts with similar terms but different carriers and or services.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed below.

What is claimed is:

1. A computerized exchange for trading container shipping contracts for the future physical transportation of cargo loaded inside a shipping container comprising:
an offer module, running on a special purpose computer, capable of posting thousands of contracts for sale at an offer price published on the computerized exchange;
a matching module, running on a special purpose computer, capable of simultaneously matching thousands of contracts offered on the computerized exchange to a corresponding bid and transforming the offers to purchased contracts; and
a settlement module, running on special purpose computer capable of notifying carriers identified by the contracts of an obligation to physically transport cargo loaded into a shipping container according to the terms of the contracts.

2. The computerized exchange of claim 1, further comprising a contract display module, running on a special purpose computer, capable of automatically displaying thousands of currently available contracts offered for purchase by registered traders.

3. The computerized exchange of claim 1, further comprising a matching engine capable of automatically matching thousands of available contracts upon the acceptance of each offer.

4. The computerized exchange of claim 1, further comprising a transfer module, running on a special purpose computer, capable of automatically transferring the ownership of thousands of contracts from one registered carrier or trader to another upon acceptance of an offer and upon the confirmation of payment or clearance.

5. The computerized exchange of claim 1, further comprising a resale module, running on a special purpose computer, capable of posting thousands of in contracts on the computerized exchange for resale.

6. The computerized exchange of claim 1, further comprising a delivery module, running on a special purpose computer, capable of booking thousands of contracts with each carrier listed on the contract, thereby facilitating the loading of cargo into a standard shipping container and the physical transportation of the container and cargo for ocean transport.

7. The computerized exchange of claim 1, further comprising a filing module, running on a special purpose computer, capable of filing thousands of reports and contracts with commissions and government entities to facilitate compliance with transport regulations.

8. The computerized exchange of claim 1, further comprising a data module, running on a special purpose computer, capable of collecting, processing and displaying thousands of data points including contract offers, bids, sales, resale prices sortable according to at least one of the following categories: carrier, departure window, container size, container type, type of shipping service, tier of shipping service, delivery date, time in transport and rating of quality of carrier.

9. The computerized exchange of elms 8, wherein the data module is searchable in order for a shipper to locate an appropriate container by searching by a parameter including one of a carrier, departure window, container size, container type, type of shipping service, tier of shipping service, delivery date, time in transport and rating of quality of carrier.

10. The computerized exchange of claim 1, further comprising shipper and carrier optimization modules, running on a special purpose computer, including one of an aggregated information module, batch container trading module, automated trading module, utilization module, yield module, benchmark module, trend module, alert module, enterprise resource planning module, shipper transport management module, shipper warehouse management module, shipping forecast module, contract portfolio module, and contract delivery module.

11. The computerized exchange of claim 10, wherein the shipper and carrier optimization modules provide analysis according to at least one of cargo ready dates, cargo ready reliabilities, cargo delivery dates, cargo delivery priorities, shipping forecasts, shipping contract terms and prices, transit times, reliabilities, frequency of service departures, average port-to-port transit times, variance from the mean transit time and the percentage of deliveries within scheduled delivery time.

12. The computerized exchange of claim 1, wherein the contract is a uniform contract for the future physical sea transportation of cargo loaded into a standard shipping container, where the contract includes least one of place(s) of receipt, place(s) of delivery, carrier name, departure date window, container size and container type.

13. The computerized exchange of claim 1, wherein the contract provides for shipping container usage and the contract specifying a price that represents the amount a shipper will pay on the date the contract is purchased or the date the container is booked and the carrier receiving payment upon acceptance of the contract.

14. The computerized exchange of claim 1, further comprising a data module, running on a special purpose computer, capable of collecting, processing and displaying thousands of data points including contract offer, sell, re-sell prices and TEUs sortable according to at least one of the following categories: carrier, departure window, container size, container type, container conversion charges and contract rating; and
the computerized exchange capable of operating each of the contract display, contract bid, bid processing, re-sell delivery, reporting and data modules simultaneously in order to provide a generally transparent and efficient marketplace for the trading shipping contracts.

15. The computerized exchange of claim 1, further comprising a contract that provides for segmentation of a shipping container and pricing of the contract according to a fractional share of a standard shipping container.

16. A non-transitory computer readable medium having stored therein instructions executable by a processor to operate a computerized exchange for trading container shipping contracts, wherein the instructions include:
first code instructions for posting thousands of the contracts for sale at an offer price posted on the computerized exchange;
second code instructions for simultaneously matching thousands of the contracts on the computerized exchange with a corresponding bid, each offered contract being transformed to a purchased contract; and
third code instructions for notifying carriers identified by the contracts of an obligation to physically transport containers according to the terms of the contracts.

17. The medium of claim 16 further including code instructions for posting thousands of purchased contracts on the computerized exchange for resale.

18. A computerized method for managing future physical transportation of cargo loaded inside a shipping container comprising the steps of:
posting, by a special purpose computer, thousands of shipping container contracts for sale at an offer price;
simultaneously matching, by the special purpose computer, thousands of the contracts to a corresponding bid and transforming the offered contracts to purchased contracts;
posting, by the special purpose computer, thousands of purchased contracts for resale; and
notifying carriers identified by the contracts of an obligation to physically transport shipping containers according to the terms of the contracts.

19. The method of claim 18 further comprising the step of displaying, by the special purpose computer, purchased contract parameters including one of a carrier, departure window, container size, container type, type of shipping service, tier of shipping service, delivery date, time in transport and rating of quality of carrier.

20. The method of claim 18 further comprising the step of providing a carrier/shipper optimization system for analyzing at least one of cargo ready dates, cargo ready reliabilities, cargo delivery dates, cargo delivery priorities, shipping forecasts, shipping contract terms and prices, transit times, reliabilities, frequency of service departures, average port-to-port transit times, variance from the mean transit time and the percentage of deliveries within scheduled delivery time.
